(19) United States
(12) Patent Application Publication
(10) Pub. No.: US 2013/0223354 A1
(43) Pub. Date: Aug. 29, 2013

(54) HS-SCCH AND HS-SICH ALLOCATION AND MONITORING IN TD-SCDMA MULTI-CARRIER SYSTEMS

(71) Applicants: Ming Yang, San Diego, CA (US); Tom Chin, San Diego, CA (US); Qingxin Chen, Del Mar, CA (US); Guangming Shi, San Diego, CA (US)

(72) Inventors: Ming Yang, San Diego, CA (US); Tom Chin, San Diego, CA (US); Qingxin Chen, Del Mar, CA (US); Guangming Shi, San Diego, CA (US)

(73) Assignee: QUALCOMM Incorporated, San Diego, CA (US)

(21) Appl. No.: 13/407,672

(22) Filed: Feb. 28, 2012

(51) Int. Cl. H04W 72/04

(52) U.S. Cl. 370/329

(57) ABSTRACT

In multi-carrier wireless communications control channels are coordinated onto a single reference frequency for scheduling communications with mobile devices. Mobile devices may monitor all available control channels on a single reference frequency rather than over multiple frequencies, thereby reducing CPU processing and power consumption.

### BACKGROUND

1. Field

Aspects of the present disclosure relate generally to wireless communication systems, and more particularly, to efficient allocation of high speed shared channels in TD-SCDMA multi-carrier systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram conceptually illustrating carrier frequencies in a multi-carrier TD-SCDMA communication system.

FIG. 5 is a flow diagram illustrating efficient channel allocation according to an aspect of the present disclosure.

FIG. 6 is a flow diagram illustrating efficient channel allocation according to one aspect of the present disclosure.

FIG. 7 is a block diagram illustrating efficient channel allocation according to one aspect of the present disclosure.

### SUMMARY

Offered is a method of wireless communication. The method includes mapping control channels on carrier frequencies to control channels on a single reference frequency. The method also includes sending the mapping to a user equipment. The method further includes scheduling communications with the user equipment on a carrier frequency(ies) using the control channels on the single reference frequency.

Offered is an apparatus of wireless communication. The apparatus includes means for mapping control channels on carrier frequencies to control channels on a single reference frequency. The apparatus also includes means for sending the mapping to a user equipment. The apparatus further includes means for scheduling communications with the user equipment on a carrier frequency(ies) using the control channels on the single reference frequency.

Offered is a computer program product for wireless communications. The computer program product includes a non-transitory computer-readable medium having program code recorded thereon. The program code includes program code to map control channels on carrier frequencies to control channels on a single reference frequency. The program code also includes program code to send the mapping to a user equipment. The program code further includes program code to schedule communications with the user equipment on a carrier frequency(ies) using the control channels on the single reference frequency.

Offered is an apparatus wireless communications. The apparatus includes a memory and a processor(s) coupled to the memory. The processor(s) is configured to map control channels on carrier frequencies to control channels on a single reference frequency. The processor(s) is also configured to send the mapping to a user equipment. The processor(s) is further configured to schedule communications with the user equipment on a carrier frequency(ies) using the control channels on the single reference frequency.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

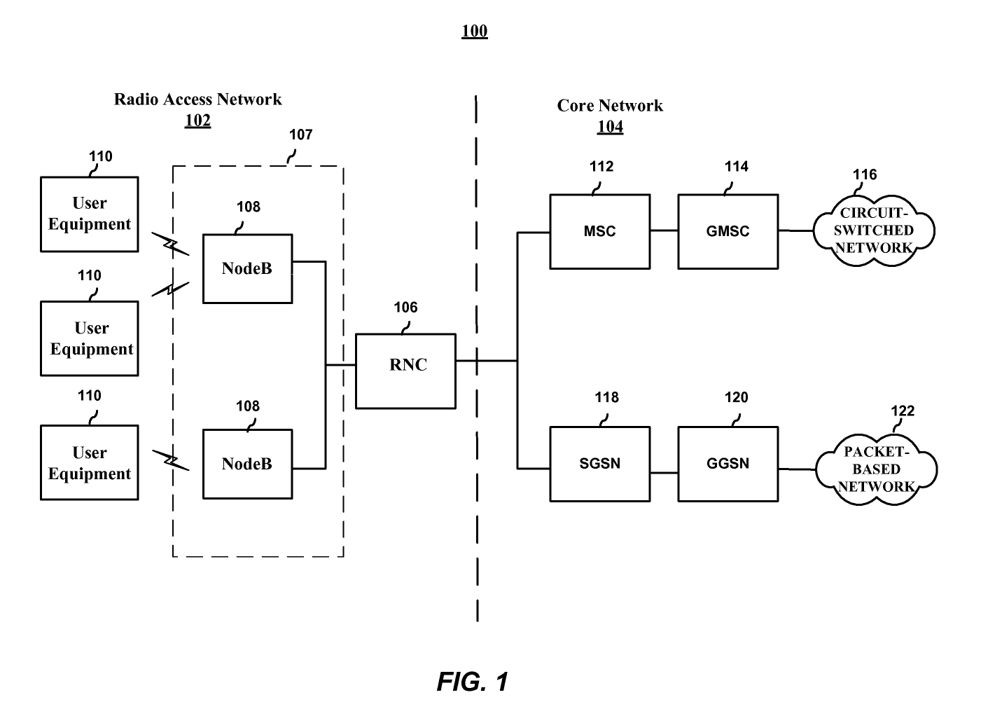

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

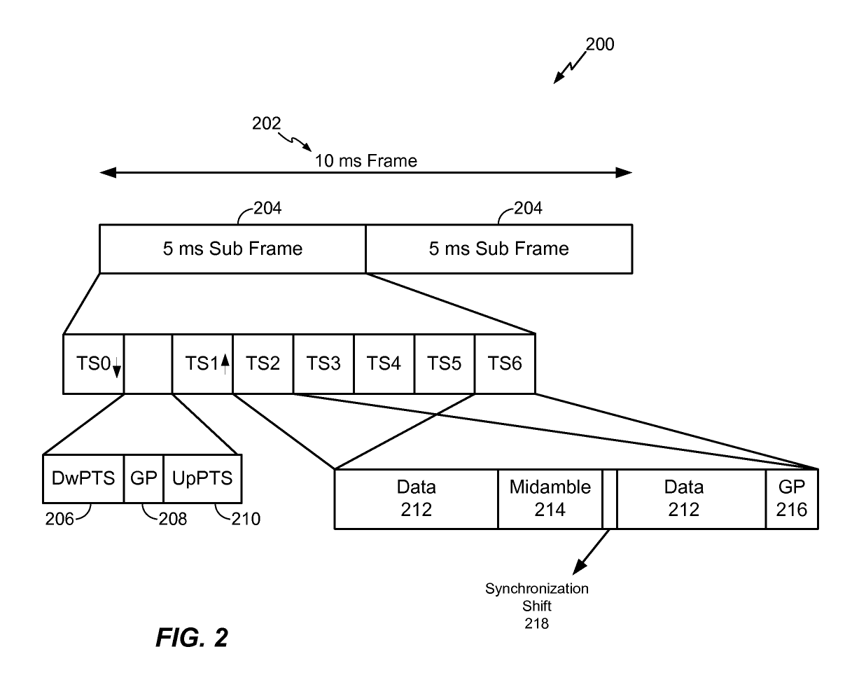

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

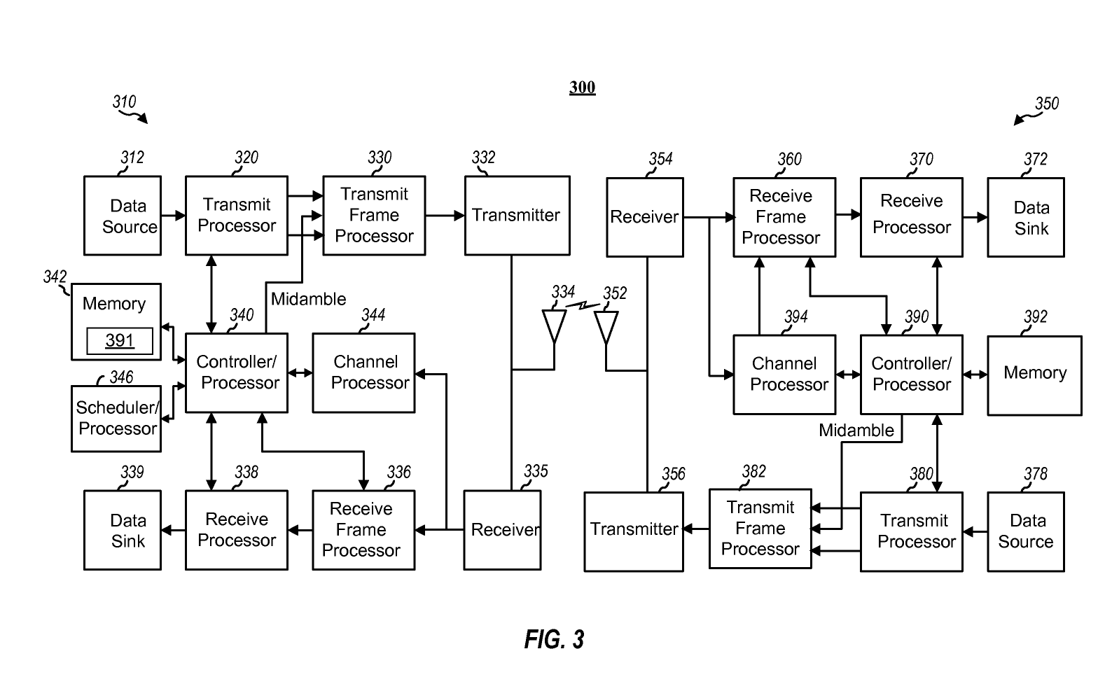

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node

B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 342 of the node B 310 may store a multi-carrier frequency mapping module 391 which, when executed by the controller/processor 340, configures the node B as indicated below. A scheduler/processor 346 at the node B 310 may be used to allocate resources to the UEs and schedule downlink and/or uplink transmissions for the UEs.

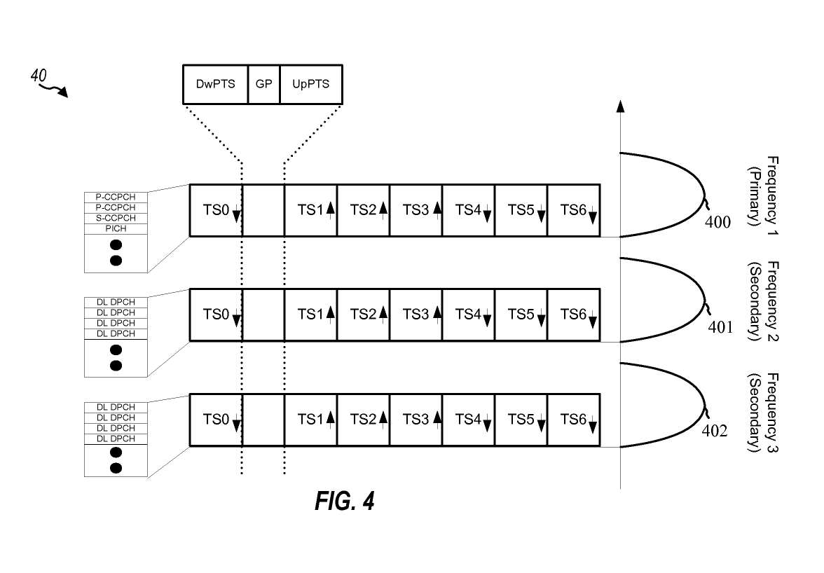

In order to provide more capacity, the TD-SCDMA system may allow multiple carrier signals or frequencies. Assuming that N is the total number of carriers, the carrier frequencies may be represented by the set T0, i=0, 1, . . . , N−1}, where the carrier frequency, F(0), is the primary carrier frequency and the rest are secondary carrier frequencies. For example, a cell can have three carrier signal frequencies whereby the data can be transmitted on some code channels of a time slot on one of the three carrier signal frequencies. FIG. 4 is a block diagram conceptually illustrating carrier frequencies 40 in a multi-carrier TD-SCDMA communication system. The multiple carrier frequencies include a primary carrier frequency 400 (F(1)), and two secondary carrier frequencies 401 and 402 (F(2) and F(3)). In such multi-carrier systems, the system overhead is transmitted on the first time slot (TS0) of the primary carrier frequency 400. In the first time slot (TS0) of the primary carrier frequency 400, the Primary Common Control Physical Channel (P-CCPCH), the Secondary Common Control Physical Channel (S-CCPCH), the Paging Indicator Channel (PICH), and the like are transmitted. The traffic channels (e.g., Downlink Dedicated Physical Channels (DL DPCHs)) may then be carried on the remaining time slots (TS4-TS6) of the primary carrier frequency 400 and on all downlink time slots (TS0 and TS4-TS6) of the secondary carrier frequencies 401 and 402. Therefore, in such configurations, a UE will receive system information and monitor the paging messages on the primary carrier frequency 400 while transmitting and receiving data on either one or all of the primary carrier frequency 400 and the secondary carrier frequencies 401 and 402.

A user equipment (UE) may monitor up to four shared control channels on a frequency to determine if communications with the UE are being scheduled by the base station (NodeB) and on what data channels. In multi-carrier operation the UE may monitor shared control channels on each available frequency carrier. For communication configurations which provide up to six frequency carriers, this means the UE may simultaneously monitor up to twenty-four shared control channels on six different frequencies. This leads to increased CPU processing and power consumption by the UE.

Proposed is a solution assigning a reference frequency where all control channels are located. Each of the control channels on the reference frequency controls the data scheduling on one of the available frequency carriers in multi-carrier operation. Thus, the UE may determine when and on what data channels communications are scheduled with the base station by monitoring the control channels on the single reference frequency. The UE may monitor all available control channels on a single reference frequency rather than over multiple frequencies, thereby reducing CPU processing and power consumption.

### HS-SCCH and HS-SICH Allocation and Monitoring in TD-SCDMA Multi-Carrier Systems.

Time Division Synchronous Code Division Multiple Access (TD-SCDMA) is based on the time division and code division to allow multiple UEs to share the same radio bandwidth on a particular frequency channel. As described above in reference to FIG. 4, the TD-SCDMA system can support multiple carriers. The TD-SCDMA standards allow a maximum of N=6 frequency carriers in multi-carrier systems.

In High-Speed Downlink Packet Access (HSDPA), the following physical channels are used:
HS-PDSCH: High-Speed Physical Downlink Shared Channel, carrying:
   User data burst
HS-SCCH: High-Speed Shared Control Channel, carrying:
   Modulation and coding scheme, channelization code, time slot and transport block size information for the data burst in HS-PDSCH.
   Hybrid Automatic Repeat reQuest (HARQ) process, redundancy version, and new data indicator information for the data burst.
   HS-SCCH cyclic sequence number which increments UE specific cyclic sequence number for each HS-SCCH transmission.
   UE identity to indicate which UE should receive the data burst allocation.
HS-SICH: High-Speed Shared Information Channel, carrying:
   Channel quality index (CQI), RTBS (Recommended Transport Block Size), and RMF (Recommended Modulation Format)
   HARQ acknowledgement/negative acknowledgment (ACK/NACK) of the HS-PDSCH transmission

On each carrier, the UE can be signaled by the Universal Terrestrial Radio Access Network (UTRAN) to monitor a subset of up to four HS-SCCHs and detect data allocation on the HS-SCCH(s), receive the allocated data on the HS-PDSCH(s), and send the appropriate Hybrid Automatic Repeat ReQuest (HARQ) acknowledgement on the HS-SICH(s).

Multi-carrier TD-SCDMA HSDPA is an important technology to increase the data rate in HSDPA. As noted above, in multi-carrier HSDPA operation, the UE monitors up to four HS-SCCHs on each frequency of these multi-carriers simultaneously. This implies that the UE may monitor HS-SCCH on up to six frequency carriers and up to 4*6=24 HS-SCCHs simultaneously. Such monitoring may be performed by a UE every 5 ms. Monitoring many channels on multiple frequencies in this manner increases UE power consumption and CPU processing substantially.

Offered is an enhancement in allocating and monitoring the HS-SCCH in multi-carrier HSDPA to alleviate the above power consumption or CPU processing concerns. In the proposal, multiple HS-SCCHs (and paired HS-SICHs) are configured on a single frequency, called a reference frequency, typically a dedicated physical channel (DPCH) (which carries a signaling radio bearer (SRB) for radio resource control (RRC) messages) is allocated on this frequency. For example, HS-SCCH 1 carried on the reference frequency corresponds to HS-PDSCH on frequency i, HS-SCCH 2 carried on the reference frequency corresponds to HS-PDSCH on frequency j, etc. for all frequencies. In this manner a UE only monitors the HS-SCCHs on the single reference frequency. Based on the decoding results of these HS-SCCHs, the UE may decode one or multiple frequencies for corresponding HS-PDSCHs dynamically. A mapping of HS-SCCHs and paired HS-SICHs may be established by a NodeB and communicated to a UE during call setup.

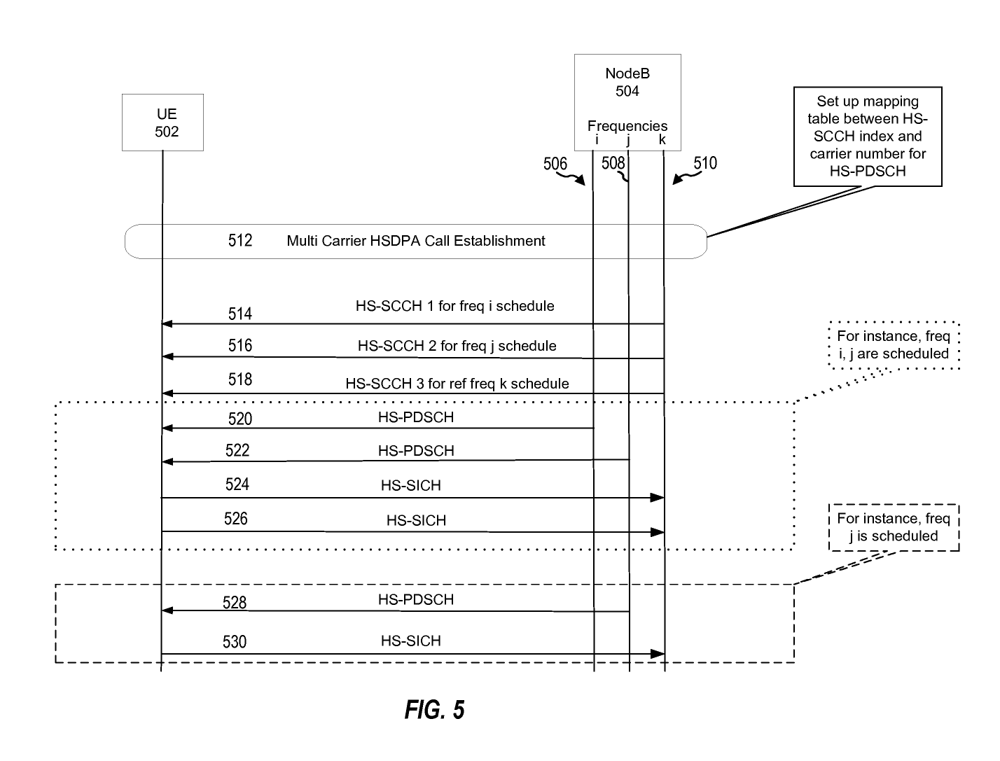

An illustrative call flow is shown in FIG. 5. A UE 502 is in communication with a NodeB 504. The NodeB 504 is operating in multicarrier mode with three frequencies. The three frequencies are frequency i 506, frequency j 508, and frequency k 510. As illustrated, frequency k 510 is the reference frequency. During multi-carrier HSDPA call establishment 512, the NodeB 504 establishes a mapping table between the HS-SCCH index and the carrier number for the HS-PDSCHs. The UE 502 then monitors only reference frequency k to receive instructions on scheduled communications. As shown in communication 514, the NodeB 504 sends HS-SCCH 1 on reference frequency k 510 for scheduling of communications on frequency i 506. As shown in communication 516, the NodeB 504 sends HS-SCCH 2 on reference frequency k 510 for scheduling of communications on frequency j 508. As shown in communication 518, the NodeB 504 sends HS-SCCH 3 on reference frequency k 510 for scheduling of communications on frequency k 510. If both frequencies i and j are scheduled, the UE may receive instructions on HS-SCCH 1 that identify appropriately scheduled communications on the HS-PDSCH of frequency i 506, as shown in communication 520. The UE may also receive instructions on HS-SCCH 2 that identify appropriately scheduled communications on the HS-PDSCH of frequency j 508, as shown in communication 522. The UE may then send a HARQ acknowledgment for those communications on the HS-SICH of frequency k 510, as shown in communications 524 and 526, respectively.

If only frequency j is scheduled, the UE may receive instructions on HS-SCCH 2 that identify appropriately scheduled communications on the HS-PDSCH of frequency j 508, as shown in communication 528. The UE may then send a HARQ acknowledgment for those communications on the HS-SICH of frequency k 510, as shown in communications 530.

In one aspect, a priority scheme may be employed with the HS-SCCHs to prioritize various HS-SCCHs (and paired HS-SICHs) with UEs. The priority scheme may be implemented in a number of different ways. In one aspect, selected HS-SCCHs are given a priority and the priority is sent to the UE during call setup. Each UE may be given a different priority scheme, meaning one UE may have HS-SCCH 1 as the highest priority channel and a different UE may have HS-SCCH 3 as the highest priority channel. The priority schemes given to a UE may rank the available HS-SCCHs according to priority, such as 1-6 with 1 being the highest priority HS-SCCH for that UE and 6 being the lowest priority HS-SCCH for that UE. Priorities may be assigned to UEs based on UE identification numbers, UE traffic patterns, or other criteria. A UE may first monitor a higher priority HS-SCCH before monitoring a lower priority HS-SCCH. The priority of HS-SCCHs for a UE may be dynamically changed during a call, with the new priority indicated to the UE. In another aspect the UE may be given a number of priority schemes ahead of time and told which priority scheme to activate either during call setup or during the call. Priority schemes may also vary depending on subframe. For example, for subframe 1 a UE may have HS-SCCH 1 as the highest priority channel, but for subframe 2 the same UE may have HS-SCCH 2 as the highest priority channel. In another aspect a flag may be used to indicate to a UE progression along prioritized HS-SCCHs. For example, the UE may monitor its assigned highest priority HS-SCCH. When the flag on the highest priority HS-SCCH is set to 0, the UE will not monitor lower priority HS-SCCHs. When the flag on the highest priority HS-SCCH is set to 1, the UE will monitor the next priority HS-SCCH in the priority chain. When the flag on the next priority HS-SCCH is set to 0, the UE will not monitor lower priority HS-SCCHs. When the flag on the next priority HS-SCCH is set to 1, the UE will monitory the next priority HS-SCCH in the priority chain, and so forth for the remaining HS-SCCHs until a flag is set to 0 or the UE has monitored all the available HS-SCCHs.

In one aspect, the chosen reference frequency may be one of the available frequencies in multi-carrier operation. In another aspect, the chosen reference frequency may be the frequency which carries the dedicated physical channel (DPCH). In another aspect, during multiple radio access bearer operation (simultaneous packet-switch (PS) and circuit-switched (CS) calls), the reference frequency may be chosen to be the frequency used for voice calls.

The proposal can provide more effective HS-SCCH configuration for multi-carrier HSDPA transmission to avoid monitoring multi carriers. Further, there is almost no processing load difference for the UE between monitoring one HS-SCCH and monitoring multiple HS-SCCHs so long as those channels are carried on the same frequency. Thus, battery power consumption may be significantly reduced compared with a UE monitoring multiple data control channels over multiple frequencies.

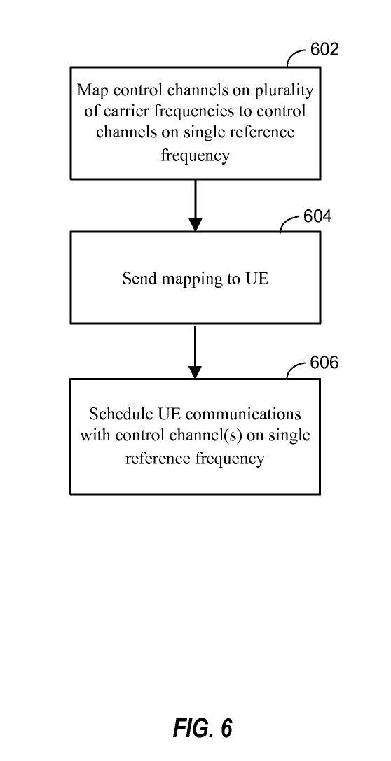

As shown in FIG. 6 a node B may map a plurality of control channels on a plurality of carrier frequencies to a plurality of control channels on a single reference frequency, as shown in block 602. A node B may send the mapping to a user equipment (UE), as shown in block 604. The node B may schedule communications with the user equipment on at least one of the plurality of carrier frequencies using the plurality of control channels on the single reference frequency, as shown in block 606.

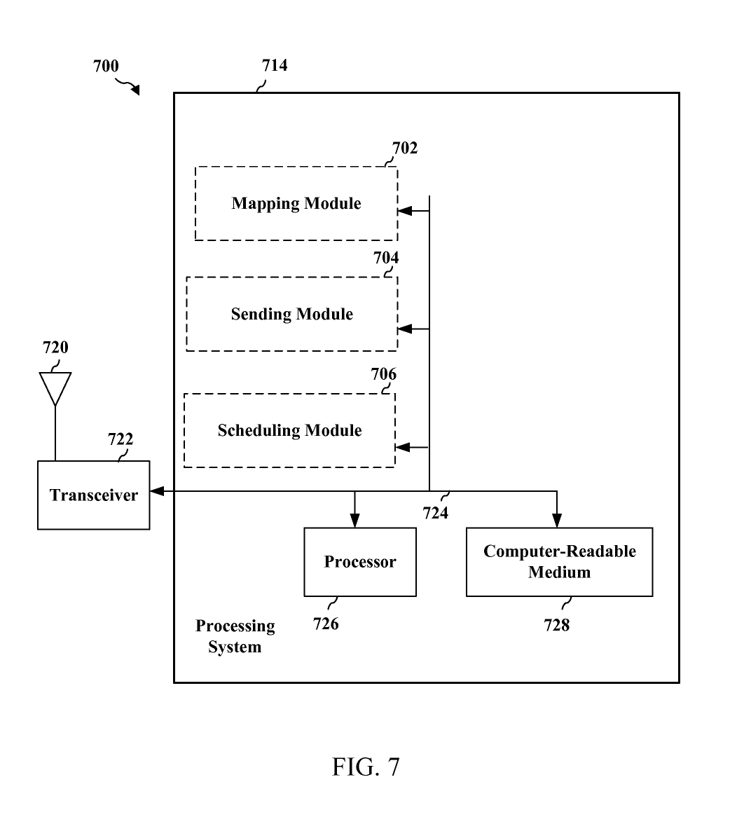

FIG. 7 is a diagram illustrating an example of a hardware implementation for an apparatus 700 employing a multi-carrier frequency mapping system 714. The multi-carrier frequency mapping system 714 may be implemented with a bus architecture, represented generally by a bus 724. The bus 724 may include any number of interconnecting buses and bridges depending on the specific application of the multi-carrier frequency mapping system 714 and the overall design constraints. The bus 724 links together various circuits including one or more processors and/or hardware modules, represented by a processor 726, a mapping module 702, a sending module 704 and a scheduling module 706, and a computer-readable medium 728. The bus 724 may also link various other circuits such as timing sources, peripherals, voltage regulators, and power management circuits, which are well known in the art, and therefore, will not be described any further.

The apparatus includes the multi-carrier frequency mapping system 714 coupled to a transceiver 722. The transceiver 722 is coupled to one or more antennas 720. The transceiver 722 provides a means for communicating with various other apparatus over a transmission medium. The multi-carrier frequency mapping system 714 includes the processor 726 coupled to the computer-readable medium 728. The processor 726 is responsible for general processing, including the execution of software stored on the computer-readable medium 728. The software, when executed by the processor 726, causes the multi-carrier frequency mapping system 714 to perform the various functions described supra for any particular apparatus. The computer-readable medium 728 may also be used for storing data that is manipulated by the processor 726 when executing software. The multi-carrier frequency mapping system 714 further includes the mapping module 702 for mapping a plurality of control channels on a plurality of carrier frequencies to a plurality of control channels on a single reference frequency. The multi-carrier frequency mapping system 714 further includes the sending module 704 for sending the mapping to a user equipment. The multi-carrier frequency mapping system 714 further includes the scheduling module 706 for scheduling communications with the user equipment on at least one of the plurality of carrier frequencies using the plurality of control channels on the single reference frequency. The mapping module 702, the sending module 704 and the scheduling module 706 may be software modules running in the processor 726, resident/stored in the computer readable medium 728, one or more hardware modules coupled to the processor 726, or some combination thereof The multi-carrier frequency mapping system 714 may be a component of the node B 310 and may include the memory 342 and/or the controller/processor 340.

In one configuration, the apparatus 700 for wireless communication includes means for mapping. The means may be the mapping module 702, the multi-carrier frequency mapping module 391, the memory 342, the controller/processor 340, and/or the multi-carrier frequency mapping system 714 of the apparatus 700 configured to perform the functions recited by the measuring and recording means. In another aspect, the aforementioned means may be any module or any apparatus configured to perform the functions recited by the aforementioned means.

In one configuration, the apparatus 700 for wireless communication includes means for sending. The means may be the sending module 704, the transceiver 722, the antenna 720/344, the transmit processor 320 and/or the multi-carrier frequency mapping system 714 of the apparatus 700 configured to perform the functions recited by the measuring and recording means. In another aspect, the aforementioned means may be any module or any apparatus configured to perform the functions recited by the aforementioned means.

In one configuration, the apparatus 700 for wireless communication includes means for scheduling. The means may be the scheduling module 706, the multi-carrier frequency mapping module 391, the controller/processor 340, the scheduler/processor 346, the memory 342, and/or the multi-carrier frequency mapping system 714 of the apparatus 700 configured to perform the functions recited by the measuring and recording means. In another aspect, the aforementioned means may be any module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication comprising:
mapping a plurality of control channels on a plurality of carrier frequencies to a plurality of control channels on a single reference frequency;
sending the mapping to a user equipment; and
scheduling communications with the user equipment on at least one of the plurality of carrier frequencies using the plurality of control channels on the single reference frequency.

2. The method of claim 1 in which the sending occurs during call setup.

3. The method of claim 1 in which the single reference frequency carries a dedicated physical channel (DPCH).

4. The method of claim 1 in which the single reference frequency comprises a frequency for radio resource control (RRC) signaling.

5. The method of claim 1 in which the single reference frequency is a frequency used for voice calls to the user equipment during multi radio access bearer operation.

6. The method of claim 1 in which the mapping comprises a priority scheme indicating a priority of shared control channels.

7. The method of claim 6 in which the priority scheme comprises a different priority of shared control channels based on different communication subframes.

8. The method of claim 6 in which the priority scheme comprises a priority flag associated with a shared control channel indicating whether the user equipment should monitor a lower priority shared control channel.

9. The method of claim 6 further comprising altering the priority scheme during a call.

10. An apparatus for wireless communications, comprising:
means for mapping a plurality of control channels on a plurality of carrier frequencies to a plurality of control channels on a single reference frequency;
means for sending the mapping to a user equipment; and
means for scheduling communications with the user equipment on at least one of the plurality of carrier frequencies using the plurality of control channels on the single reference frequency.

11. A computer program product for wireless communications, the computer program product comprising:
a non-transitory computer-readable medium having program code recorded thereon, the program code comprising:
program code to map a plurality of control channels on a plurality of carrier frequencies to a plurality of control channels on a single reference frequency;
program code to send the mapping to a user equipment; and
program code to schedule communications with the user equipment on at least one of the plurality of carrier frequencies using the plurality of control channels on the single reference frequency.

12. An apparatus for wireless communication, comprising:
a memory; and
at least one processor coupled to the memory, the at least one processor being configured:
to map a plurality of control channels on a plurality of carrier frequencies to a plurality of control channels on a single reference frequency;
to send the mapping to a user equipment; and
to schedule communications with the user equipment on at least one of the plurality of carrier frequencies using the plurality of control channels on the single reference frequency.

13. The apparatus of claim 12 in which the sending occurs during call setup.

14. The apparatus of claim 12 in which the single reference frequency carries a dedicated physical channel (DPCH).

15. The apparatus of claim 12 in which the single reference frequency comprises a frequency for radio resource control (RRC) signaling.

16. The apparatus of claim 12 in which the single reference frequency is a frequency used for voice calls to the user equipment during multi radio access bearer operation.

17. The apparatus of claim 12 in which the mapping comprises a priority scheme indicating a priority of shared control channels.

18. The apparatus of claim 17 in which the priority scheme comprises a different priority of shared control channels based on different communication subframes.

19. The apparatus of claim 17 in which the priority scheme comprises a priority flag associated with a shared control channel indicating whether the user equipment should monitor a lower priority shared control channel.

20. The apparatus of claim 17 in which the at least one processor is further configured to alter the priority scheme during a call.
